(19) United States
(12) Patent Application Publication
(10) Pub. No.: US 2025/0164451 A1
(43) Pub. Date: May 22, 2025

(54) NON-DESTRUCTIVE BATTERY PACK INSPECTION AND IMAGING

(71) Applicant: EVident Battery, Inc., Somerville, MA (US)

(72) Inventors: Jinqiang Ning, Somerville, MA (US); Chenwei Wu, Somerville, MA (US)

(21) Appl. No.: 18/951,629

(22) Filed: Nov. 18, 2024

Related U.S. Application Data
(60) Provisional application No. 63/600,253, filed on Nov. 17, 2023.

(51) Int. Cl. G01N 29/44; G01N 29/04; G01N 29/265; H01M 10/42

(52) U.S. Cl. CPC G01N 29/44; G01N 29/04; G01N 29/265; H01M 10/4285; G01N 2291/023; G01N 2291/103; H01M 2220/20

(57) ABSTRACT

A method and system for applying non-destructive inspection tests to battery packs of electronic vehicles (EV) is disclosed herein. A mechanical shaker is positioned below a subject EV and vibration input is applied to the battery pack at the base of the EV. Differential vibration sensors read output of the mechanical shaker as passed through the battery pack. Variations in the resultant vibration output are indicative of any of a number of failure modes that are trained into an AI model that analyzes the detected vibration output. Example apparatus for positioning the testing apparatus under the EV include a rover or a motorized undercarriage gantry.

### CROSS-REFERENCE TO RELATED APPLICATION(S)

This application claims priority to and the benefits of U.S. Provisional Application No. 63/600,253, titled “NON-DESTRUCTIVE BATTERY PACK INSPECTION AND IMAGING” filed on Nov. 17, 2023. The content of the aforementioned application is herein incorporated by reference in its entirety.

### TECHNICAL FIELD

The present invention relates to non-destructive inspection and, more particularly, to non-destructive inspection of a structure for defects.

### BACKGROUND

Non-destructive inspection (NDI) of structures involves thoroughly examining a structure without harming the structure or requiring its significant disassembly. NDI is also known as non-destructive examination/evaluation (NDE) or non-destructive testing (NDT). NDI is typically preferred to avoid the schedule, labor, and costs associated with removal of a part for inspection, as well as avoidance of the potential for damaging the structure. NDI is advantageous for many applications in which a thorough inspection of the exterior and/or interior of a structure is required. For example, NDI tests are commonly used in the aircraft industry to inspect aircraft structures for any type of internal or external damage to or defects (flaws) in the structure. Inspection may be performed during manufacturing or after the completed structure has been put into service, including field testing, to validate the integrity and fitness of the structure. In the field, access to interior surfaces of the structure is often restricted, requiring disassembly of the structure, introducing additional time and labor.

### BRIEF DESCRIPTION OF THE DRAWINGS

FIG. 1 is an illustration of an EV battery pack.

FIG. 2 is a graphic flow chart illustrating the process of performing an NDI test with a testing apparatus.

FIGS. 3A and 3B are isometric and front perspective views (respectively) illustrating a treaded rover testing apparatus.

FIGS. 4A-C are isometric, top, and side perspectives (respectively) illustrating an undercarriage gantry testing apparatus.

FIGS. 5A and 5B are top and bottom perspective views (respectively) illustrating an autonomous rover testing apparatus.

FIG. 6 is a pair of side views illustrating a measurement state and a mobility state of an autonomous rover.

FIG. 7 is a zoomed in view illustrating a stabilization device of a testing apparatus.

FIGS. 8A-C are perspective views illustrating various positioning adjustments of a motorized rotating undercarriage gantry testing apparatus.

FIG. 9 is a zoomed in view illustrating a mechanical excitation probe element of a testing apparatus.

FIG. 10 is a zoomed in view illustrating a differential sensor probe element of a testing apparatus.

FIG. 11 is a flow diagram illustrating an example method of measuring an excitation signal to identify a performance-related property of a battery pack.

FIG. 12 is a graphic flow chart of an example method of analyzing and reporting on excitation data in an NDI scheme.

FIG. 13 is a block diagram illustrating an example mixture of experts architecture for generating predictions related to a battery pack.

FIG. 14 is a block diagram illustrating an example computer system, in accordance with one or more embodiments.

FIG. 15 is a block diagram illustrating an example ML system, in accordance with one or more embodiments.

### DETAILED DESCRIPTION

Battery packs are the most valuable single component of an electric vehicle (EV), and inspection thereof in a non-destructive manner aids in facilitating EV production, resale, repair, and data collection. Efficient and accurate NDI methods for EV battery packs are therefore crucial for supporting the continued growth of the EV market and the reliability of the vehicles themselves. However, current inspection methods for EV battery packs often rely on manual operations performed by technicians. These operations can be time-consuming, labor-intensive, and unreliable for detecting potential failures. Moreover, many existing inspection methods are invasive or destructive, requiring partial disassembly of the battery pack or even causing damage to battery pack components during the inspection process. Such methods can lead to undetected early failures and premature replacement of the entire battery pack, creating a substantial financial burden for both manufacturers and consumers as well as performance and safety concerns.

Disclosed herein is an NDI scheme connected to EV battery packs. The disclosed scheme involves positioning a mechanical excitation probe in contact with an exterior facing surface of an EV and vibrating the surface such that an excitation signal (i.e., a detectable mechanical wave) corresponding to the vibrating passes through the battery pack of the EV. Excitation data associated with the excitation signal after it passes through the battery pack is collected via a differential sensor probe and an indication of a performance-related property of the battery pack is received. For example, the performance-related property may pertain to whether a feature of the battery pack is performing as expected, predict the battery pack's performance level over time, indicate a certain type and/or severity of damage to the battery pack, or indicate some other performance-related feature of the battery pack. This NDI scheme overcomes the limitations of existing battery pack inspection methods by detecting failure modes of the battery pack without damaging or disassembling the battery pack or EV. In doing so, the present NDI scheme helps combat climate change by improving the maintenance and longevity of EVs, making it easier for automobile drivers to rely on EVs instead of fossil-fuel powered vehicles.

The present solution applies to all types of EV battery packs. In some embodiments, excitation data is stored in a database corresponding to the particular design or brand of battery pack being inspected. Features are extracted from the excitation data that are specific to a performance-related property associated with the particular design or brand of battery pack being inspected.

In some embodiments, multiple sensors are positioned at different physical locations and collect excitation data related to different diagnostic tasks. Existing methods for analyzing data from multiple sensors which collect data under different operating conditions often assume static information distribution across data samples and across sensor locations, which rarely holds true. This assumption leads to the problem of “modality competition,” where one sensor or location dominates the joint latent space including the data from each sensor, suppressing crucial features from other sensors and resulting in compromised analysis results. Different diagnostic tasks may also require task-specific ways of selecting and combining data from sensors at different locations, but many existing models cannot adaptively leverage the most relevant features from each sensor location and diagnostic task without compromising the diversity of multi-sensor features shared across different diagnostic tasks.

Further disclosed herein is a mixture of experts (MoE) architecture for generating predictions related to a battery pack. The architecture integrates data from sensors in different physical locations and performing different diagnostic tasks by processing data with both sensor-specific modules and a module that groups data by diagnostic task. The combined output of these modules accounts for insights that the collected data from each sensor can provide for each diagnostic task, allowing predictions related to each diagnostic task to be made with a high degree of accuracy.

In some embodiments, the NDI test is performed using a testing apparatus that positions itself under a subject EV. Example testing apparatus configurations include tracked rovers, autonomous rovers, and undercarriage gantries. Once the excitation signal has passed through the battery pack, differential sensor probes positioned at a predetermined distance from the mechanical excitation probe measure the change in the excitation signal, which is indicative of the resonance of vibrations in the battery pack. In some embodiments, data captured from the differential sensor probes is processed by an artificial intelligence (AI) model that is trained on a database of excitation data corresponding to the battery pack.

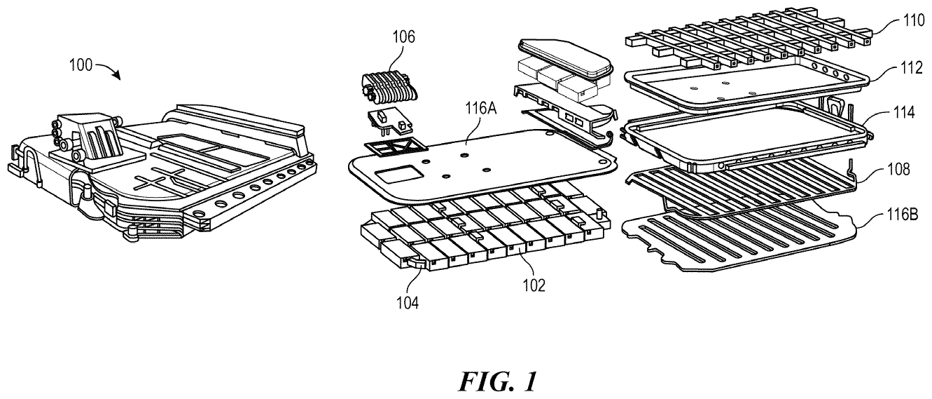

FIG. 1 is an illustration of an EV battery pack 100. EV battery packs 100 tend to have a familiar structure. At the time of writing, there are relatively few battery pack designs on the market and the relevant manufacturers tend to reuse battery pack designs across numerous automobile models. Typical EV battery packs 100 are rather large and heavy, often comprising about a quarter of the overall vehicle weight (this varies from vehicle to vehicle) and spanning the entirety of the chassis space between the axels.

The battery pack 100 is positioned at the base of the vehicle to lower the center of mass (reducing the rollover potential) and to provide improved strength to the chassis. The consistent placement of battery packs 100 across both makes and models of EVs assists in overall consistency of the NDI scheme. The ability of an NDI scheme to inspect the battery pack of one EV is therefore generally predictive of how the NDI scheme will perform for battery packs in other EVs. Furthermore, the relatively low number of battery pack configurations as compared to available models of EV reduces the number of required training scenarios for an AI model to be used in conjunction with an NDI scheme.

Table 1 below illustrates a clearance height for a selection of EVs on the market at the time of writing. This table illustrates that the overall difference across significantly varied makes and models is less than ten inches.

TABLE 1

| | | RIDE HEIGHT/ |
|---|---|---|
| MAKE | MODEL | CLEARANCE (INCHES) |
| Tesla | Model S | 4.6-6.3 |
| Tesla | Model X | 5.4-8.1 |
| Rivian | R1T | 8.0-14.4 |
| Rivian | R1S | 8.0-14.4 |
| Lucid | Air | 4.8-6.9 |
| Ford | Mustang Mach-E | 5.7 |
| Chevrolet | Bolt EV | 6.3 |
| Audi | e-tron | 6.9 |
| BMW | iX3 | 7.2 |
| Mercedes-Benz | EQC | 5.4 |

Referring to FIG. 1, the battery pack 100 includes an array of battery cells 102. The battery cells 102 are connected to a controller 104 and a battery junction box 106. The battery cells 102 are connected to a cooling system 108 and include an internal battery chassis 110. The prior recited elements 102-110 rest in a tray 112, are surrounded by a structural frame 114, and are covered by an upper 116A and lower housing 116B. The lower housing 116B is typically exposed on an exterior facing surface of the vehicle. In some embodiments, the input and output probes used for an NDI test are applied to the lower housing 116B.

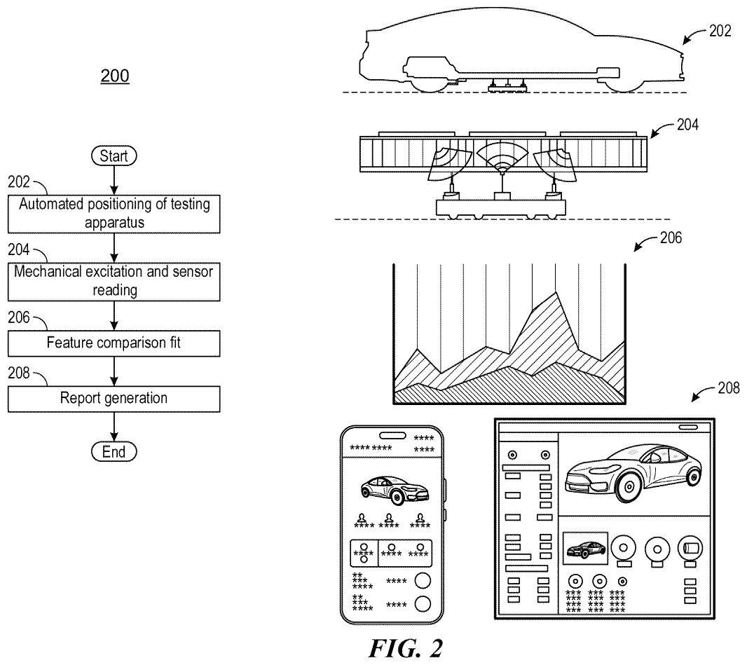

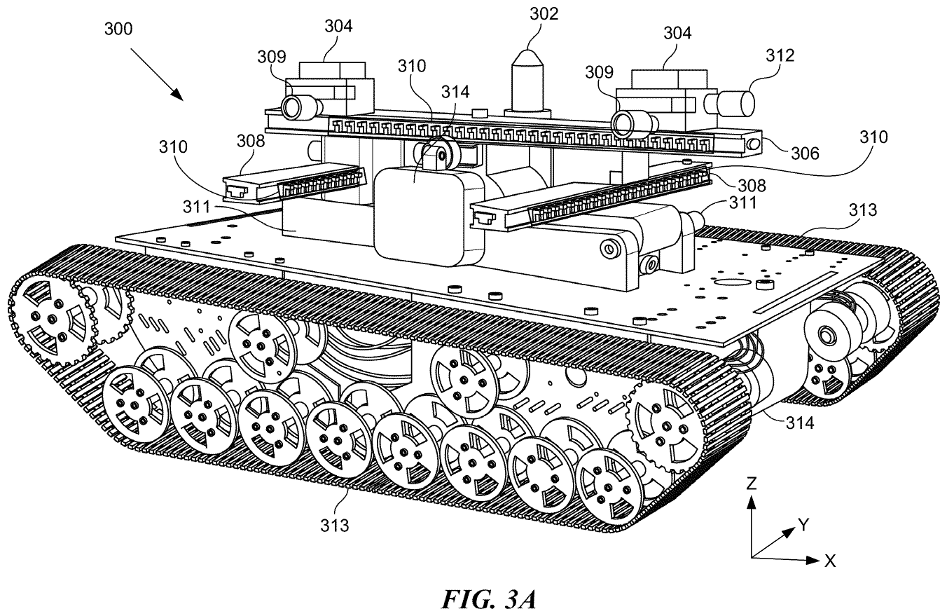

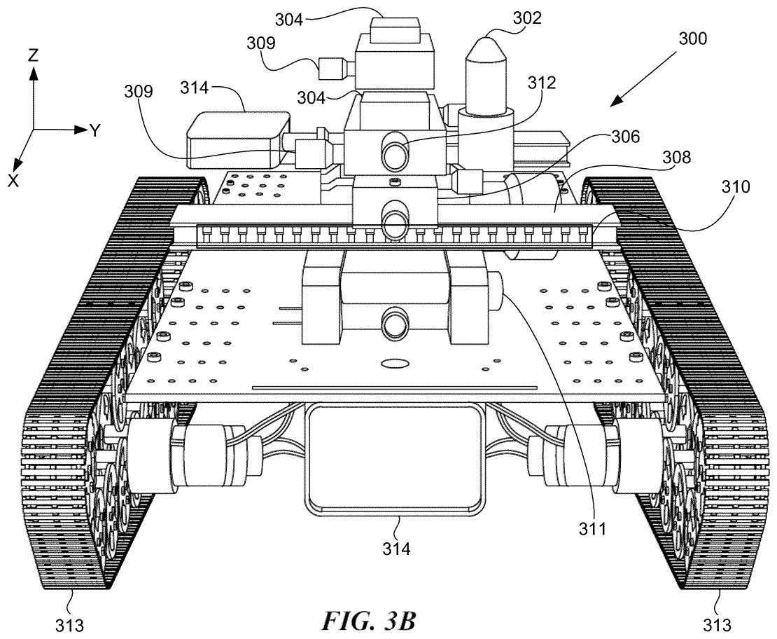

FIG. 2 is a graphic flow chart illustrating the process of performing an NDI test with a testing apparatus 200. In step 202, a testing apparatus is positioned under the subject vehicle. Positioning varies based on make and model of the EV as well as configuration of the testing apparatus. Different testing apparatus configurations may be used in different settings. FIG. 2 depicts a rover configuration for a testing apparatus, example embodiments of which are described in FIGS. 3, 5 and 6.

Regardless of its particular configuration, a testing apparatus will include a suite of sensors. In some embodiments, this suite includes visual sensors that are trained to identify fingerprint points on predetermined makes and model of EVs or marks on the ground that the testing apparatus aligns to, proximity sensors that identify boundaries of components of the subject vehicle, and/or magnetic sensors that enable alignment with external objects. These sensors aid in positioning the testing apparatus appropriately in relation to the vehicle and, in some embodiments, enable the testing apparatus to position itself for an NDI test automatically.

Once the testing apparatus is in position under the vehicle, probes included in the testing apparatus are positioned for both vibrating an exterior facing surface of the EV and measuring a corresponding excitation signal after the excitation signal passes through the battery pack of the EV. The probes are positioned based on the make and model of the subject vehicle such that the excitation signal passes through the battery pack and the excitation signal can be measured afterwards.

In some embodiments, the probes are positioned a predetermined distance apart from one another to localize performance-related properties of the battery pack. For example, probes are applied to different portions of the battery pack to detect whether a component fault in the battery pack occurred in the front or back of the pack. In some embodiments, the probes are applied to portions of the lower housing 116B of the battery pack with differing expected surfaces that are a predetermined distance apart on the interior of the lower housing 116B (e.g., probe is beneath battery cells 102 or beneath internal battery chassis 110). Probes are applied to different portions of the battery pack to account for differing portions of the battery pack have different expected resonances corresponding to the same performance-related property of the battery pack. In some embodiments, the probes are positioned symmetrically (e.g., about the point of vibration), or asymmetrically based on an expected profile of the excitation signal. Probe placement operates on a per battery pack basis and prioritizes collection of differential data relative to the structure of the subject battery pack.

In step 204, the testing apparatus applies mechanical excitation and reads subsequent measurements from multiple points. The application of mechanical excitation involves vibrating an exterior facing surface of the EV, which generates a corresponding excitation signal. In some embodiments, the mechanical excitation applies a varied set of waveforms such as high and low amplitude excitation, sparse and dense excitation, as well as sin/cos, square, triangle, and sawtooth waveforms, each waveform having a unique corresponding excitation signal. Varying the waveforms to inspect for different performance-related properties enables isolation of data relating to each inspection. In some circumstances, a given excitation signal may cause a vibration in the battery pack that continues after inspection for a given performance-related property has ended and inspection for another performance-property has begun. Varying the waveforms used for each inspection enables analytical models to isolate data from different inspections that would otherwise overlap.

Excitation data associated with a measurement of the excitation signal after the excitation signal passes through the battery pack is collected by one or more sensor probes coupled with the testing apparatus. In some embodiments, this data is time series data corresponding to different measurements of the excitation signal at different times, and/or differential data corresponding to two or more sensor probes taking measurements from different physical locations at the same time(s), wherein the differences between those measurements taken from different locations are analyzed. The excitation data may describe certain features associated with the excitation signal after the excitation signal passes through the battery pack, including amplitude (peak and valley values), pattern (gradient, shape, dense/sparse features), a three-axis (x-y-z) vibration speed, a displacement, a frequency, and/or an acceleration. In some embodiments, once collected, the excitation data is transmitted (e.g., via Wifi, Bluetooth, or another suitable wireless protocol known in the art) from the testing apparatus to a backend or host server for post processing and analysis.

In step 206, collected excitation data is supplied to a trained AI model that performs feature fit to any of a plurality of performance-related properties. In some embodiments, the AI model is trained to extract features from the excitation data indicative of at least one of a plurality of performance-related properties, including external physical damage, internal structural damage, welding cracks, enclosure sealing damage, mechanical fastener torque loss or damage, adhesive delamination, physical damage of connectors, battery cell deformation, severe corrosion, coolant leakage, or abrasion between parts. The AI model is trained on data regarding the characteristics of various excitation signals after passing through a battery pack as detected from a predetermined probe positioning.

In some embodiments, AI model training makes use of large multiplicities of example excitation data (e.g., hundreds of thousands or millions) indicating different performance-related properties and various presentations thereof. The examples vary in physical location and/or severity of the indicated performance-related property (e.g., data pertaining to a beam crack may reference a crack anywhere along relevant beams). The models applied include an AI model for performance-related property location identification, and an AI model for performance-related property type identification.

In step 208, a report on the analyzed excitation data is generated. In some embodiments, further AI models and/or machine learning prediction models are employed to generate an outlook on the future life of the battery pack. In some embodiments, the outlook includes a prediction of the remaining useful life of the battery pack (i.e., a prediction of for how long the battery pack will reliably power the EV), and/or a financial value estimation (e.g., a prediction of the battery pack's resale value, scrap value, repair cost, and/or a prediction of the financial value of the EV as a whole). In some embodiments, a final report is delivered to a device (e.g., computer or smartphone) via client application software which describes detected performance-related properties (e.g., by at least one of the property's type, extent, physical location, etc.), the impact of those properties on the battery pack (e.g., potential for water ingress or flame egress), and/or recommended actions to resolve any detected problems (e.g., check bolt torque or battery pack flange flatness). From start to end, the above-described process, performed in real-time, is measured in minutes. The process is completed within an average charging window at a super charger station, during performance of routine maintenance at a garage, or as a battery pack comes off a production line.

### NDI Testing Apparatuses

FIGS. 3A and 3B are isometric and front perspective views (respectively) illustrating a treaded rover testing apparatus (“treaded rover”) 300. The treaded rover 300 includes a mechanical excitation probe 302 for vibration input that extends to an exterior facing surface of an EV and facilitates a high frequency (0-10 kHz) and low amplitude (0-20N) vibration signal into the exterior facing surface through intermittent physical contact. In some embodiments, the exterior facing surface is the lower housing 116B of a battery pack of the EV. The mechanical excitation probe 302 operates at varied settings (e.g., waveform, frequency, and amplitude configurations) to test for and distinguish between different performance-related properties. Changes in vibration settings enable the ability to detect time delays in output detection, the output being a measurement of an excitation signal corresponding to the vibrating after the excitation signal passes through the battery pack. Timestamps indicating when a given excitation signal begins and ends enable computation of time delay of the signal through the battery pack. In some embodiments, the mechanical excitation probe 302 has a power supply independent of the other components of the treaded rover 300.

Differential sensor probes 304 are positioned at multiple locations to measure the excitation signal after passing through the battery pack. In some embodiments, the differential sensor probes 304 are based on a piezoelectric or MEMS (Micro-Electro-Mechanical Systems) measuring principles. Positioning the differential sensor probes 304 at multiple locations enables differential readings of the excitation signal as measured by each differential sensor probe 304. In some embodiments, the differential sensor probes 304 include magnets which secure the differential sensor probes 304 to an exterior facing surface of the EV, holding the differential sensor probes 304 in place during an NDI test. In some embodiments, the differential sensor probe 304 has a power supply independent of the other components of the treaded rover 300.

The treaded rover 300 includes an x-track 306 along which the probes 302, 304 move in the x-direction and a y-track 308 along which the x-track 306 moves to adjust the positions of the probes 302, 304 in the y-direction. In some embodiments, the x-track 306 and y-track 308 are used to make fine-grained adjustments to the positioning of the probes 302, 304 in the x-y plane with increments as small as one millimeter. The differential sensor probes 304 are held in place by positioning knobs 309 which lock the differential sensor probes 304 in place when tightened. When the positioning knobs 309 are loosened, the differential sensor probes 304 are unlocked and allowed to freely move along the x-track 306. In some embodiments, ruler markings 310 are included along the x-track 306 and y-track to aid in positioning the differential sensor probes 304.

The treaded rover 300 also includes a z-stage 311 coupled with the x-track 306 and y-track 308 which extends in the +z-direction and retracts in the −z-direction to adjust the positioning of the probes 302, 304 in the z-direction. In some embodiments, the differential sensor probes 304 are coupled with the x-track 306 by detachable clamps which are detachable from the x-track 306, enabling the differential sensor probes 304 to be positioned independently of the x-track 306, y-track 308, and z-stage 311. The detachable clamps are detached from the x-track by loosening an attachment knob 312 and can be reattached to the x-track 306 by tightening the attachment knob 312 once the clamp is put back into place. Adjustment of the positioning of the probes 302, 304 enables adaptation of the treaded rover 300 to multiple battery packs and EV designs, including configurations not yet in use.

The treaded rover 300 further includes a drive system (e.g., a tread or wheels) 312. The drive system 313 enables a high degree of freedom in adjusting the location of the treaded rover 300. This high degree of freedom enables much larger positioning adjustments than the adjustments made to the probes 302, 304 by the x-track 306 and y-track 308, which are limited to the distance covered by the x-track 306 and y-track 308 themselves. Thus, adjustments to the positioning of the mechanical excitation probe 302 of a greater magnitude than those which can be made by the x-track 306 and y-track 308 are made by moving the entire treaded rover 300 using the drive system 313. In some embodiments, the treaded rover 300 is controlled by a remote controller which activates the drive system 313 and signals the direction of movement to the treaded rover 300.

In some embodiments, the treaded rover 300 includes one or more lighting fixtures 314. The lighting fixtures 314 illuminate the space surrounding the treaded rover 300, aiding in positioning of the treaded rover 300 in low light environments. In some embodiments, at least one lighting fixture 314 is rotatable such that the lighting fixture 314 illuminates space above the treaded rover 300 (e.g., the underside of an EV) or space to the side of the treaded rover 300, depending on its configuration. A rotatable lighting fixture 314 is depicted in FIG. 3 as attached to the x-track 306; the lighting fixture 314 faces in the −y-direction in FIG. 3A and in the +z-direction in FIG. 3B.

In some embodiments, the treaded rover 300 further includes a processor configured to automatically position the treaded rover 300 under an EV and to automatically position the probes 302, 304 in contact with an exterior facing surface of the EV by automatically adjusting the x-track 306, y-track 308, and z-stage 311. In some embodiments, the treaded rover 300 includes a wireless transceiver for over-the-air (OTA) data transmission. OTA data transmission enables delivery of data collected by the differential sensor probes 304 as well as receipt of software and firmware updates.

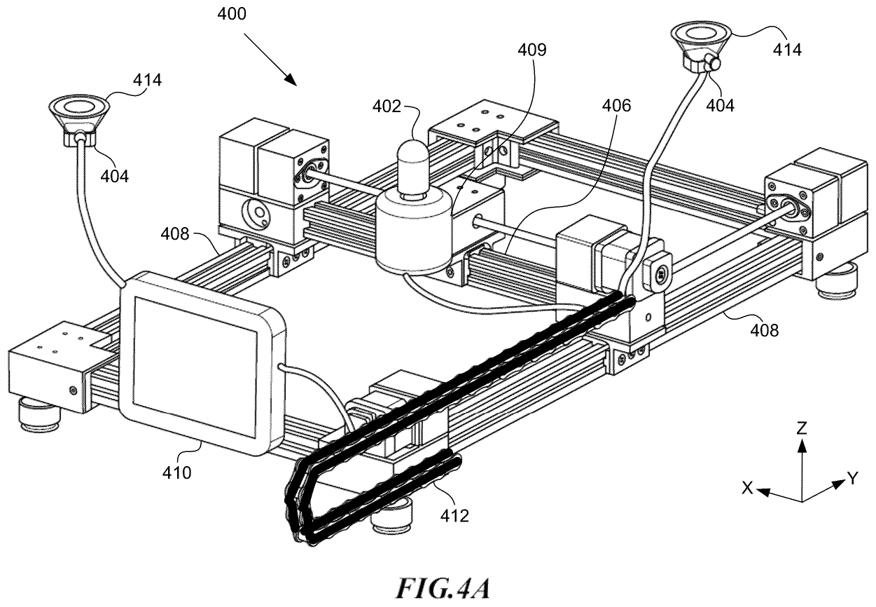

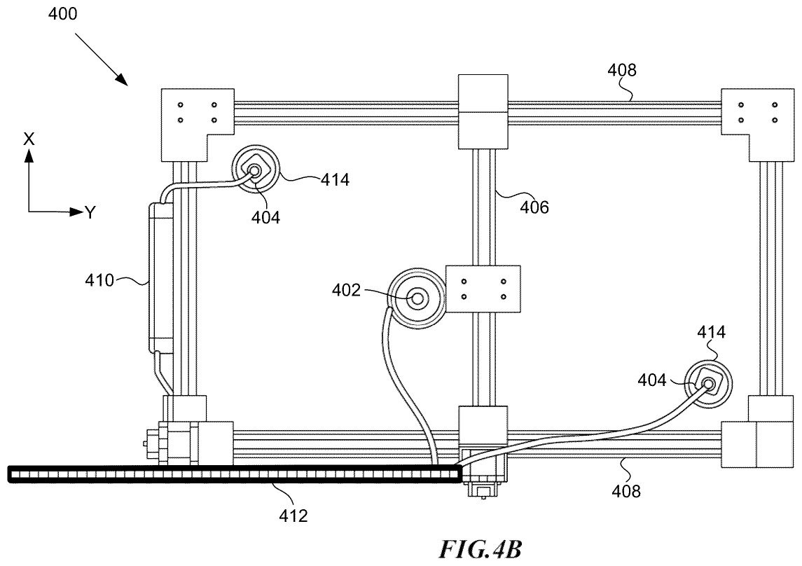

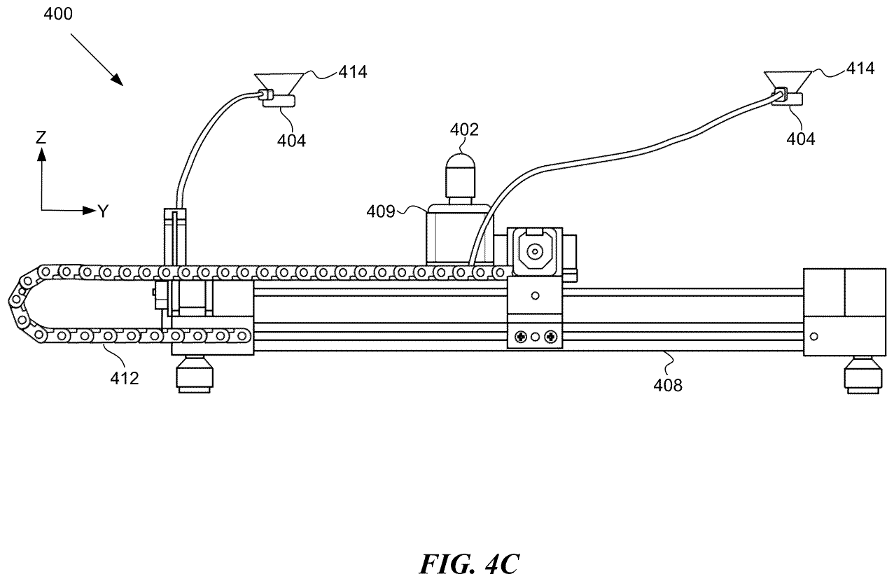

FIGS. 4A-C are isometric, top, and side perspectives (respectively) illustrating an undercarriage gantry testing apparatus (“undercarriage gantry system”) 400. An undercarriage gantry is a stationary gantry positioned under an EV and is a desirable configuration where there is low local control over traffic near the location of the NDI test (e.g., such as parking lots or charging stations) and a rover could be run over or otherwise damaged by uncoordinated or unsupervised vehicles. The undercarriage gantry system 400 is an alternate embodiment to the treaded rover 300 but shares many elements described as being present on the treaded rover 300. The undercarriage gantry system 400 includes a mechanical excitation probe 402, a set of differential sensor probes 404, an x-track 406 and a y-track 408 for adjusting the positioning of the probes 402, 404. In some embodiments, the mechanical excitation probe 402 is coupled with a riser 409 which extends and retracts the mechanical excitation probe 402 in the z-direction.

In some embodiments, the undercarriage gantry system 400 further includes a control panel 410. The control panel 410 is configured to display information about an ongoing NDI test and/or display an interface for controlling components of the undercarriage gantry system 400. The undercarriage gantry system 400 may also include a cable carrier 412 for cable management. Cables connected to the undercarriage gantry system 400 can be inserted into the cable carrier 412 for improved organization and protection. The cable carrier 412 is made of a flexible material which allows the cables to move along with components of the undercarriage gantry system 400 without becoming entangled with one another or interfering with the operation of the undercarriage gantry system 400.

The differential sensor probes 404 are connected to the undercarriage gantry system 400 in various ways in different embodiments. The differential sensor probes 404 may be connected via a wired connection, as illustrated in FIG. 4. Alternatively, the differential sensor probes 404 may be wireless and each differential sensor probe 404 may be powered by a power supply independent of the other components of the undercarriage gantry system 400. There are also various ways of securing the differential sensor probes to an external facing surface of the EV. For example, suction cups 414 may be coupled with the differential sensor probes 404 and used to hold the differential sensor probes 404 in place during an NDI test. The differential sensor probes 404 may also be secured to the exterior facing surface using an adhesive material, magnets as described in relation to FIG. 3, or a combination of an adhesive material, magnets, and/or suction cups 414 used in conjunction with one another.

The undercarriage gantry system 400 is ground mounted and operates below a vehicle. Unlike the treaded rover 300 which moves using a drive system 313 to position under an EV, the EV of interest drives over the undercarriage gantry system 400 and the undercarriage gantry system 400 adjusts to the EV to begin inspection of the vehicle's battery pack. The undercarriage gantry system 400 allows for x-direction movement of the probes 402, 404 along the x-track 406 and y-direction movement of the probes 402, 404 by moving the x-track 406 along the y-track 408. The x-track 406 and y-track 408 allow the probes 402, 404 to be positioned in the x-y plane with a high degree of freedom. In some embodiments, the x-track 406 and y-track 408 are used to make fine-grained adjustments to the positioning of the probes 402, 404 in the x-y plane with increments as small as 12.7 micrometers.

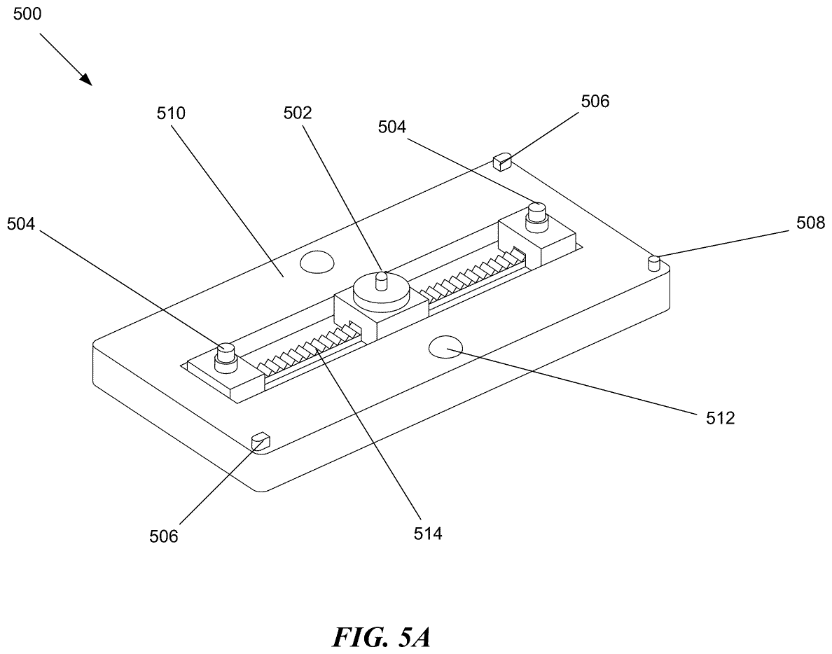

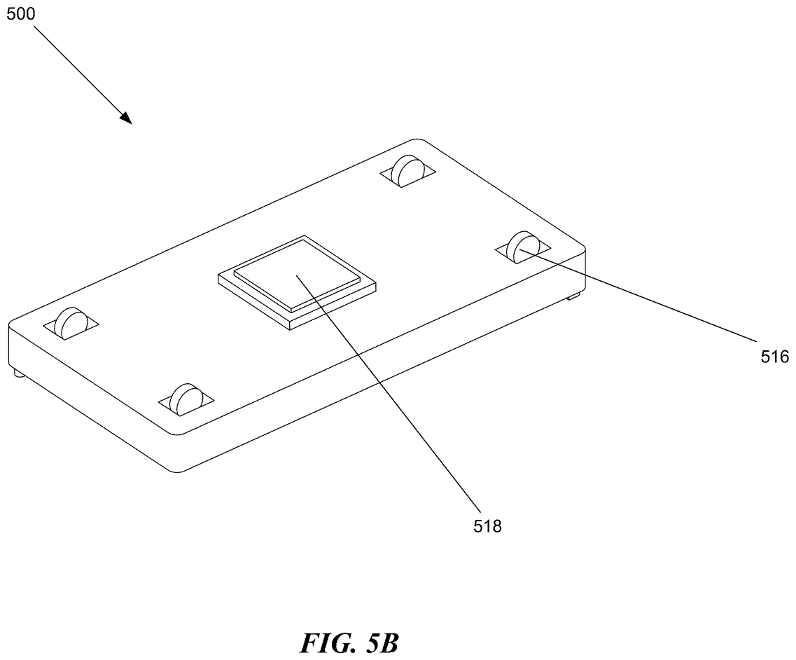

FIGS. 5A and 5B are top and bottom perspective views (respectively) illustrating an autonomous rover testing apparatus (“autonomous rover”) 500. The autonomous rover 500 includes a mechanical excitation probe 502 for vibration input that extends to an exterior facing surface of an EV and facilitates a high frequency (0-10 kHz) and low amplitude (0-20N) vibration signal into the exterior facing surface through intermittent physical contact. In some embodiments, the exterior facing surface is the lower housing 116B of a battery pack of the EV. The mechanical excitation probe 502 operates at varied settings (e.g., waveform, frequency, and amplitude configurations) to test for and distinguish between different performance-related properties. Changes in vibration settings enable the ability to detect time delays in output detection, the output being a measurement of an excitation signal corresponding to the vibrating after the excitation signal passes through the battery pack. Timestamps indicating when a given excitation signal begins and ends enable computation of time delay of the signal through the battery pack.

Differential sensor probes 504 are positioned at multiple locations to measure the excitation signal after passing through the battery pack. In some embodiments, the differential sensor probes 504 are based on a piezoelectric or MEMS (Micro-Electro-Mechanical Systems) measuring principles. Positioning the differential sensor probes 504 at multiple locations enables differential readings of the excitation signal as measured by each differential sensor probe 504.

The autonomous rover 500 further includes a set of mobility sensors 506 that enable navigation and collision avoidance with vehicle wheels and other physical obstacles. Example mobility sensors 506 include optical sensors, sonic sensors, infrared sensors, magnetic sensors or other suitable computer vision sensor suites known in the art. Using data received from the mobility sensors 506, the autonomous rover 500 automatically positions itself under an EV in a location from which an NDI test of the battery pack of the EV is carried out. The autonomous rover 500 further includes a wireless transceiver 508 for OTA data transmission. OTA data transmission enables delivery of data collected by the differential sensor probes 504 as well as receipt of software and firmware updates.

The autonomous rover 500 includes a body 510 that houses components of a robotics mobile platform 512 including operating electronics such as a controlling unit, battery or other power source, a gyroscope sensor to monitor the flatness of ground conditions, and motors for mobility. In some embodiments, the body 510 additionally houses a probe track 514. The probe track 514 enables adjustment of the positioning of the differential sensor probes 504 and mechanical excitation probe 502. Adjustment of the probes 502, 504 enables adaptation of the autonomous rover 500 to multiple battery packs and EV designs, including configurations not yet in use.

On the underside of the autonomous rover 500 is the drive system (e.g., wheels or a tread) 516 and a stabilization device 518. The drive system 516 enables a high degree of freedom in adjusting the location of the autonomous rover 500. This high degree of freedom enables much larger positioning adjustments than the adjustments made to the probes 502, 504 by the probe track 514, which are limited to the distance covered by the probe track 514 itself. Thus, adjustments to the positioning of the mechanical excitation probe 502 of a greater magnitude than those which can be made by the probe track 514 are made by moving the entire autonomous rover 500 using the drive system 516.

Performing an NDI test requires a great deal of consistency for the data to be effective. However, performing the vibrating and measuring the excitation signal corresponding to the vibrating from the same testing apparatus (e.g., the rover) results in a potential for error, as vibration in the mechanical excitation probe 502 may cause corresponding vibration at a differential sensor probe 504, distorting measurements taken by the differential sensor probe 504. This challenge is mitigated by extending a stabilization device 518 during inspection of the battery pack to reduce vibration of the autonomous rover 500. Extension of the stabilization device 518 and probes 502, 504 pinches the autonomous rover 500 between the ground and the subject EV, stabilizing the autonomous rover 500 to a greater degree than when the stabilization device 518 is not extended, reducing the potential for error. The stabilization device 518 retracts during movement to avoid collision with the ground.

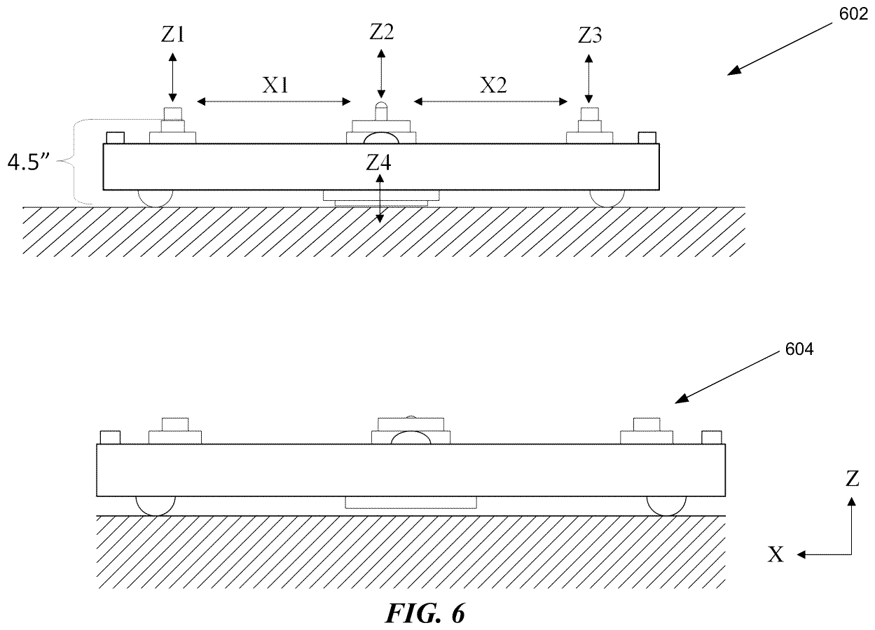

FIG. 6 is a pair of side views illustrating a measurement state 602 and a mobility state 604 of an autonomous rover 500. During the mobility state 604, the autonomous rover 500 automatically drives under the vehicle. During this motion, the mechanical excitation probe 502 and differential sensor probes 504 on top of the autonomous rover 500 retract in the −z-direction and the stabilization device 518 at the bottom of the autonomous rover 500 retracts in the +z-direction.

During the measurement state 602, the autonomous rover 500 is stationary. The mechanical excitation probe 502 and differential sensor probes 504 on top of the autonomous rover 500 extend in the +z-direction to be in contact with an exterior facing surface of an EV. Similarly, the stabilization device 518 at the bottom of the autonomous rover 500 extends in the −z-direction until the stabilization device 518 is in contact with the ground. The mechanical excitation probe 502 and/or the differential sensor probes 504 further adjust along the probe track 514 in the x-direction to align to a predetermined position on the exterior facing surface. In some embodiments, the probe track 514 is employed to make small adjustments to the positioning of the probes 502, 504 based on detected error in the positioning of the autonomous rover 500. The probe track 514 employs a more precise adjustment servo than the drive system 516. Thus, the probe track 514 reduces operation time for the autonomous rover 500 because the positioning of the probes 502, 504 can be corrected without making multiple attempts at driving the autonomous rover 500 into position.

In some embodiments, the autonomous rover 500 measures approximately 4 feet by 2 feet (ex: 50″ by 25″). In some embodiments, the autonomous rover 500 is 4.5″ tall as measured from the ground to a base of the probes 502, 504. At those dimensions, the adjustment range of the probe track 514 is, for example, 40″ and facilitates error correction from 0 to 36″. The probes 502, 504 extend upwards between 0 and 10″ and the stabilization device 518 extends downward between 0 and 5″. These proposed dimensions are intended as illustrative and not intended as limiting. Variation in the extension ranges and rover size is contemplated based on testing requirements and component size.

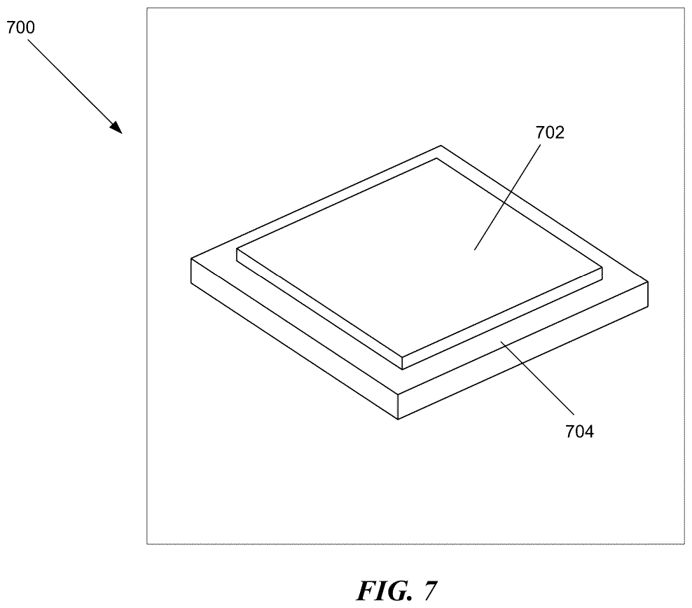

FIG. 7 is a zoomed in view illustrating a stabilization device 700 of a testing apparatus. While reference is made in FIG. 7 to the stabilization device 518 of FIG. 5B, the stabilization device 700 is employed by other embodiments, such as those not found on a rover. The stabilization device 700 includes a motorized column 702 that has large flat surface to retract (+z) and extend (−z) with linear locomotion. When the flat surface of the motorized column 702 is placed on the ground, the motorized column 702 pinches the testing apparatus between the ground and the subject EV, stabilizing the testing apparatus to a greater degree than when the stabilization device 700 is not extended, reducing the potential for errors related to vibration of the testing apparatus itself. The stabilization device 700 retracts during movement to of the testing apparatus to avoid collision with the ground. The stabilization device 700 further includes a housing 704 to contain retracted portions of the motorized column 702.

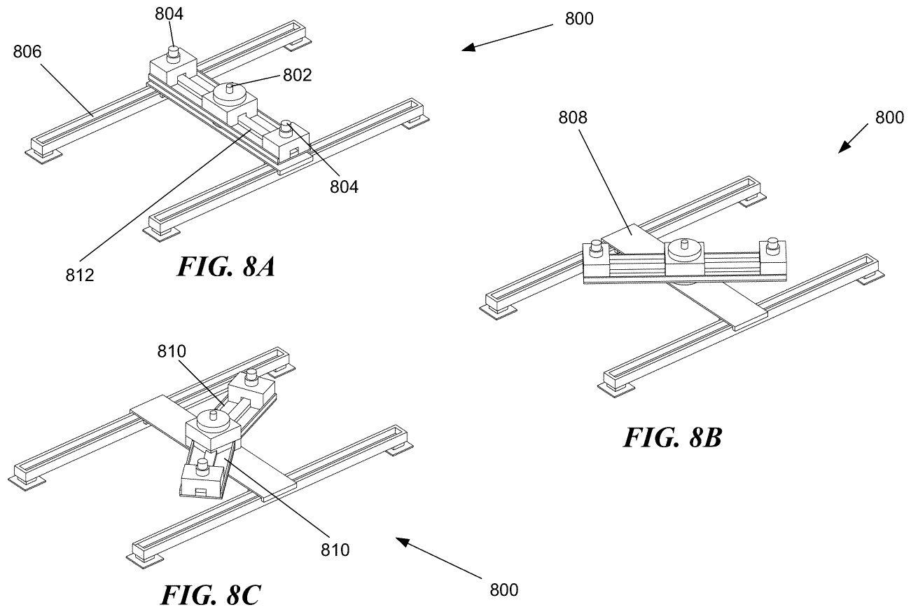

FIGS. 8A-C are perspective views illustrating various positioning adjustments of a motorized rotating undercarriage gantry testing apparatus (rotating gantry system) 800. An undercarriage gantry is a stationary gantry positioned under an EV and is a desirable configuration where there is low local control over traffic near the location of the NDI test (e.g., such as parking lots or charging stations) and a rover could be run over or otherwise damaged by uncoordinated or unsupervised vehicles. The rotating gantry system 800 is an alternate embodiment to the autonomous rover 500 but shares many elements described as being present on the autonomous rover 500. In some embodiments, the rotating gantry system 800 includes a mechanical excitation probe 802, a set of differential sensor probes 804, mobility sensors 506 for navigation, motors for adjusting the position of the rotating gantry system 800, and a wireless transceiver 508 for OTA data transmission.

The rotating gantry system 800 includes a base rail 806 that affixes to the ground and enables linear locomotion of a base arm 808. Rotational arms 810 further enable rotational locomotion of the differential sensor probes 504. Rotational arms 810 are attached to the base arm 808 and employ 180-degree rotation to allow the probes 502, 504 to be positioned in the x-y plane with a high degree of freedom. In some embodiments, the rotational arms 810 include a probe track 812 that enables translation of the differential sensor probes 804 along the rotational arms 810. In some embodiments, the mechanical excitation probe 802 is enabled to translate along the probe track 812 while the rotational arms 810 are aligned along a single axis.

The rotating gantry system 800 is ground mounted and operates below a vehicle. Unlike the autonomous rover 500 which automatically positions itself under an EV, the EV of interest drives over the rotating gantry system 800 and the rotating gantry system 800 adjusts to the EV to begin inspection of the vehicle's battery pack. The rotating gantry system 800 allows for x-direction movement of the probes 802, 804 by moving the base arm 808 along the base rail 806 and x-y plane rotational movement of the probes 802, 804 by moving the rotational arms 810.

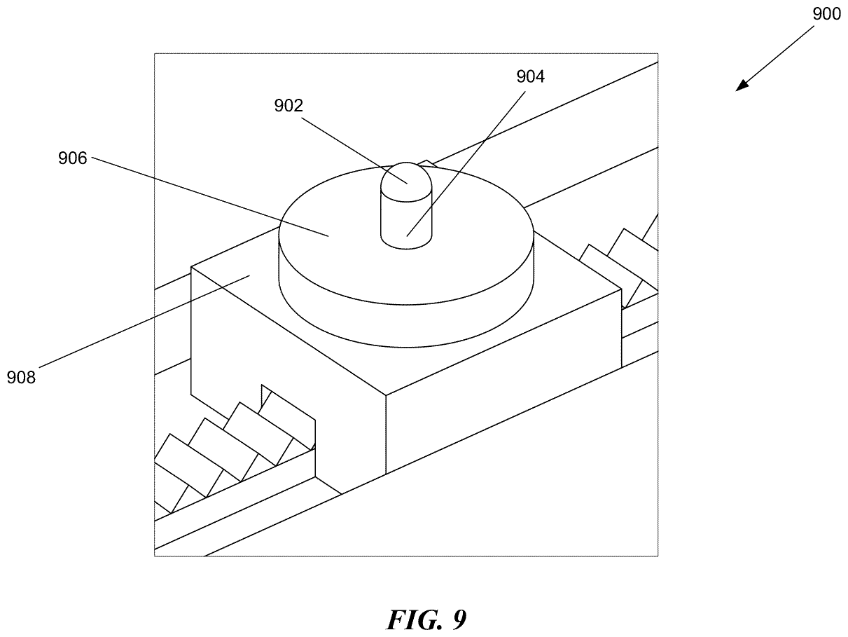

FIG. 9 is a zoomed in view illustrating a mechanical excitation probe 900 element of a testing apparatus. The mechanical excitation probe 900 includes an impact head 902 that makes physical contact with an exterior facing surface of an EV. In some embodiments, the shape of the impact head 902 is a hemisphere, a flat surface, a cone, or a hat shape. The impact head 902 is constructed from a number of different materials across embodiments including plastic, rubber, and high-density foam.

The mechanical excitation probe 900 further employs an extender probe 904 that connects an internal vibration motor 906 and the impact head 902. The extender probe 904 enables adjustment of the height of the mechanical excitation probe 900 in a range of approximately 0 to 10″. The vibration motor 906 causes vibration in the impact head 902 and extends the impact head 902 to be in contact with the exterior facing surface (e.g., retract (−z) and extend (+z) the mechanical excitation probe 900 with linear locomotion). The vibration motor 906 further employs a force sensor that maintains consistent contact conditions between the impact head 902 and the exterior facing surface. The mechanical excitation probe 900 is mounted on a track adjustment module 908 that adjusts the mechanical excitation probe 900 along a track in either of the x- or y-directions. This adjustment corrects for positioning errors of the mechanical excitation probe 900 and positions the mechanical excitation probe 900 to vibrate the exterior facing surface in a predetermined location for battery pack inspection.

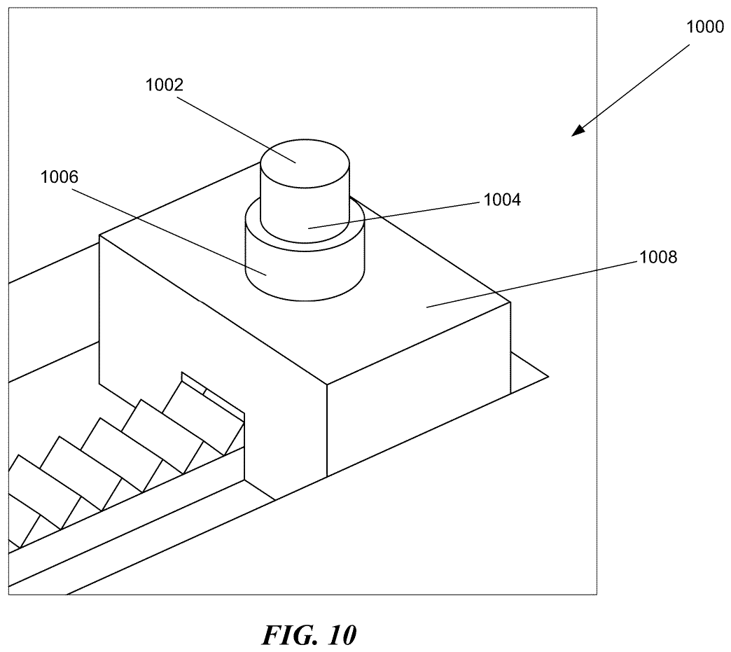

FIG. 10 is a zoomed in view illustrating a differential sensor probe 1000 element of a testing apparatus. In some embodiments, the differential sensor probe 1000 includes a 3-axial measurement sensor head 1002 that can measure vibration frequencies from 0 to 50 KHz.

The differential sensor probe 1000 further employs an extender probe 1004 that connects an internal extension motor 1006 and the sensor head 1002. The extender probe 1004 enables adjustment of the height of the differential sensor probe 1000 in a range of approximately 0 to 10″. The extension motor 1006 extends the sensor head 1002 to be in contact with the exterior facing surface (e.g., retract (−z) and extend (+z) the differential sensor probe 1000 with linear locomotion). The extension motor 1006 further employs a force sensor that maintains consistent contact conditions between the sensor head 1002 and the exterior facing surface. The sensor head 1002 is mounted on a track adjustment module 1008 that adjusts the differential sensor probe 1000 along a track in either of the x or y directions. This adjustment corrects for positioning errors of the differential sensor probe 1000 and positions the differential sensor probe 1000 to measure an excitation signal having passed through a battery pack in a predetermined location for inspection of the battery pack.

### Excitation Signal Measurement Method

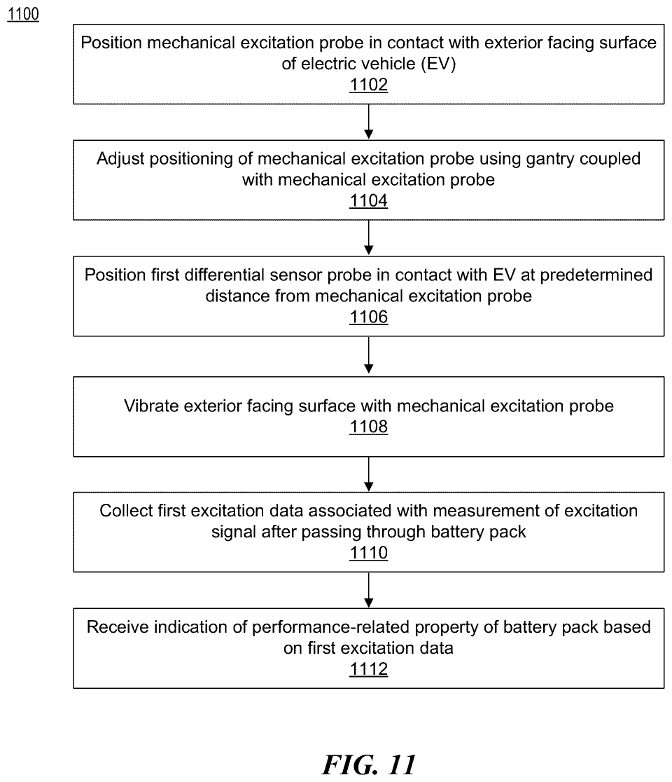

FIG. 11 is a flow diagram illustrating an example method of measuring an excitation signal 1100 to identify a performance-related property of a battery pack. In step 1102, a mechanical excitation probe is positioned in contact with an exterior facing surface of an EV. In some embodiments, the exterior facing surface is the lower housing of a battery pack of the EV. In step 1104, the positioning of the mechanical excitation probe is adjusted using a gantry coupled with the mechanical excitation probe. In some embodiments, the positioning of the mechanical excitation probe is adjusted to align with a predetermined location on the exterior facing surface where the mechanical excitation probe will vibrate the exterior facing surface. The predetermined location is based on the make and model of the EV and battery pack type and facilitates vibrations wherein a corresponding excitation signal passes through the battery pack.

In step 1106, a first differential sensor probe is positioned in contact with the EV at a predetermined distance from the mechanical excitation probe. The predetermined distance is again based on the make and model of the EV and battery pack type and positions the differential sensor probe to collect excitation data associated with the excitation signal after the excitation signal has passed through the battery pack. In step 1108, the exterior facing surface is vibrated with the mechanical excitation probe. In response to the vibrating, the corresponding excitation signal travels through the battery pack. The form or character of the excitation signal is configurable on an EV by EV basis. During a given test, the excitation signal takes one or more forms. For example, in some embodiments, the excitation signal has a single set of characteristics (amplitude, frequency, wave type, or other suitable variations of signal character). In other embodiments, the excitation signal varies in character to identify or confirm different conditions of the examined battery pack.

Subsequently, in step 1110, first excitation data associated with a measurement of the excitation signal after the excitation signal passes through the battery pack is collected via the first differential sensor probe. In some embodiments, the first excitation data describes at least one of an amplitude (peak and valley values), a pattern (gradient, shape, dense/sparse features), a three-axis (x-y-z) vibration speed, a displacement, a frequency, or an acceleration associated with the excitation signal after the excitation signal passes through the battery pack. Measuring these and/or additional features of the excitation signal after it has passed through the battery pack allows for the resonance of vibrations in the battery pack to be documented and analyzed to discern performance-related properties of the battery pack. In embodiments where the exterior facing surface is the battery pack itself, the excitation signal passes only through the battery pack before being measured by the differential sensor probe.

Measuring the entire excitation signal requires collection of a very large amount of data that is computationally expensive to collect and analyze in its entirety. Thus, in some embodiments, the first excitation data consists of sample measurements of the excitation signal collected at predetermined time intervals that are not continuous with one another. For example, the sample measurements may be of 0.5-1 second in duration each and be spaced apart in time by a similar 0.5-1 second time interval during which no data is collected. The sample measurements capture the characteristics of the excitation signal without collecting data associated with the entire excitation signal, enabling an accurate analysis of the excitation signal to be completed in a less computationally expensive manner.

In some embodiments the collected excitation data is stored in a product-specific database corresponding to the battery pack. The product-specific database contains data tailored to the unique characteristics of the specific battery pack or wider battery pack type corresponding to the database. In some embodiments, the product-specific database includes data indicative of a product-specific performance-related property associated with the battery pack. A product-specific performance-related property is a performance-related property that is associated with the particular brand or type of battery pack corresponding to the database. In some embodiments, the data for the product-specific database is collected by measuring excitation data associated with a battery pack of the specified type that has a known fault status (e.g. a performance-related property of the battery pack indicating the battery pack is not functioning properly).

In step 1112, an indication of a performance-related property of the battery pack based on the first excitation data is received. In some embodiments, this indication is received from an AI model trained to extract features from the excitation data indicative of at least one of a plurality of performance-related properties, including external physical damage, internal structural damage, welding cracks, enclosure sealing damage, mechanical fastener torque loss or damage, adhesive delamination, physical damage of connectors, battery cell deformation, severe corrosion, coolant leakage, or abrasion between parts. The AI model is trained on data regarding the characteristics of various excitation signals after passing through a battery pack as detected from a predetermined probe positioning.

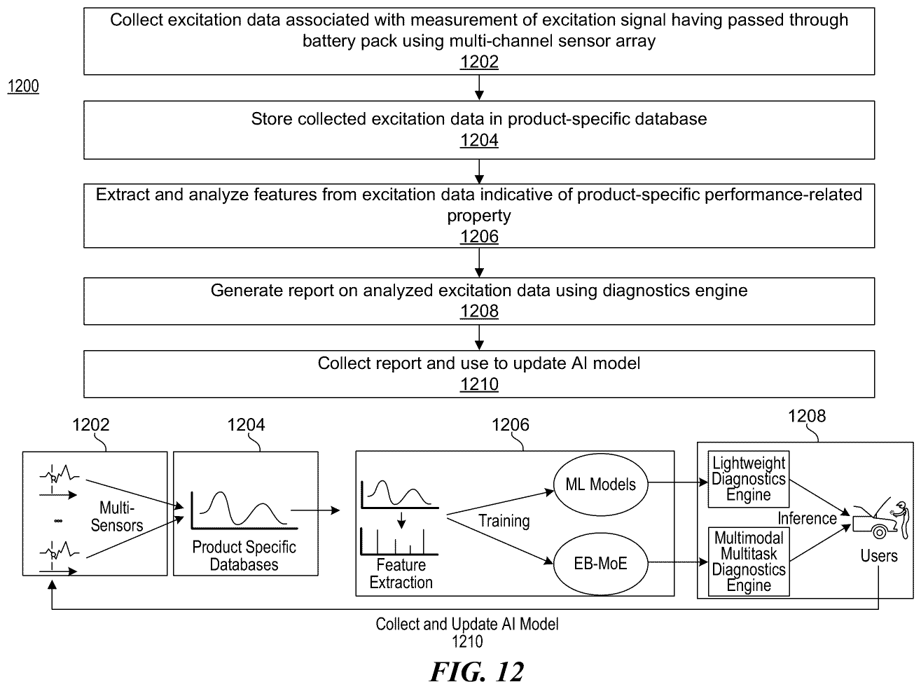

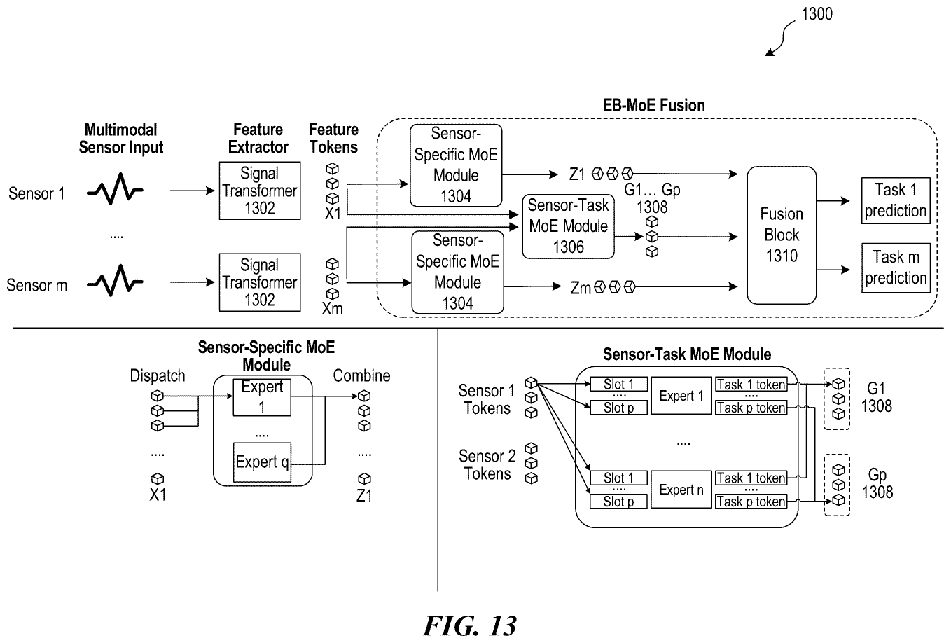

In some embodiments, a second differential sensor probe in a different physical location than the first differential sensor probe is also in contact with the EV and collects second excitation data associated with a measurement of the excitation signal after the excitation signal passes through the battery pack contemporaneously with the first differential sensor probe collecting the first excitation data. The first and second excitation data are then combined into a differential data set wherein the differences in measurements taken by the first and second differential sensor probes are stored for analysis. One or more of the methods of analyzing collected excitation data discussed in relation to FIGS. 12 and 13 below are used to analyze the differential data set.

### Analysis Software

FIG. 12 is a graphic flow chart of an example method of analyzing and reporting on excitation data in an NDI scheme. In step 1202, a multi-channel sensor array is used to collect excitation data associated with a measurement of an excitation signal that has passed through a battery pack that is the subject of an NDI test. Sensors from the multi-channel sensor array are positioned in contact with the EV in physical locations a predetermined distance away from the other sensors. The distance between the sensors enables the multi-channel sensor array to collect signals related to features such as vibration frequency, angular displacement, and acceleration across the x, y, and z axes corresponding to multiple physical locations on the battery pack. The multi-sensor approach enables the detection of diverse failure modes in precise locations on the battery pack, such as torque loss in bolts, misalignments in internal beams, and thermal anomalies. In some embodiments, the multi-channel sensor array includes one or more differential sensor probes.

In step 1204, the excitation data collected by the multi-channel sensor array is stored in a product-specific database corresponding to the battery pack. The product-specific database contains data tailored to the unique characteristics of the specific battery pack or wider battery pack type corresponding to the database. In some embodiments, the product-specific database includes data indicative of a product-specific performance-related property associated with the battery pack. A product-specific performance-related property is a performance-related property that is associated with the particular brand or type of battery pack being inspected.

In step 1206, features are extracted from the excitation data that are indicative of a product-specific performance-related property associated with the battery pack and analyzed. These features are extracted using an AI model trained using content in the product-specific database, ensuring that the AI model is tailored to feature extraction for the particular battery pack being inspected and that its output will accurately reflect the physical properties of the battery pack. The AI model extracts time-series data, such as maximum, minimum, mean, variance, standard deviation, root mean square, skewness, kurtosis, crest factor, form factor, and interquartile ranges for each axis. The extracted features are particularly sensitive to z-axis data, where structural changes in a battery pack are highly evident. In some embodiments, features are extracted by applying a sliding time window and chunk data processing to the excitation data, which creates overlapping time windows that capture temporal dynamics in the excitation data.

In some embodiments, the AI model is trained using one or more classical machine learning models. These classical models are relatively low-cost computationally and generate results quickly. For example, the model may be trained using Support Vector Machines (SVM), Random Forests, and/or Extreme Gradient Boosting (XGBoost). In some embodiments, the AI model is trained using one or more deep learning architectures either instead of or in addition to the one or more classical machine learning models. These deep learning architectures are more computationally expensive than the classical models but are generally more versatile and produce more accurate analysis results. For example, the deep learning architecture many be a Long Short-Term Memory network (LSTM), Temporal Convolutional Network (TCN), Convolutional Neural Network combined with an LSTM (CNN+LSTM), or a transformer. LSTMs are adept at capturing long-term dependencies in sequential data, making them suitable for analyzing time-series excitation data from a battery pack. TCNs leverage causal and dilated convolutions to efficiently model temporal dependencies, offering parallelism and flexible receptive fields. The CNN+LSTM architecture integrates convolutional layers for spatial feature extraction before using LSTMs to capture temporal dependencies, making it effective for modeling both local and sequential patterns in the excitation data. Transformers utilize self-attention mechanisms to capture global dependencies across entire sequences, enabling them to model complex interactions within the excitation data.

In some embodiments, the AI model is trained using multi-modal multi-task learning. Multi-modal multi-task learning is a system for combining unique information from various data sources that collect data in different physical locations and carry out different diagnostic tasks. Multi-modal multi-task learning is effective at handling input from multiple sensors performing different diagnostic tasks at once. For example, multi-modal multi-task learning is a desirable approach when one sensor captures data specific to the location where it is in contact with a battery pack and captures a specific type of data (e.g., indicative of bolt torque loss, welding cracks, or battery cell deformation) but a different sensor is positioned in contact with the battery pack in a different physical location captures a type of data indicative of a different performance-related property to be diagnosed. In some embodiments, the unique information from various sensors is combined using an MoE architecture. This architecture is described in more detail in relation to FIG. 13 below.

In step 1208, a diagnostics engine including the AI model generates a report on the analyzed excitation data. When the AI model is trained using multi-modal multi-task learning, the diagnostic engine is a multi-modal multi-task diagnostics engine for handling complex diagnostic tasks. Otherwise, the diagnostics engine is a lightweight diagnostics engine which is less optimized for complex diagnostic tasks but requires fewer computing resources. The diagnostics engine performs a feature fit, wherein the features extracted from the excitation data are compared to known features of a performance-related property. In some embodiments where the performance-related property is a product-specific performance-related property, the known features are determined by an analysis of the content of the product-specific database by the AI model.

The diagnostics engine generates a probability estimate of the performance-related property being present in the subject battery pack based on the closeness of the fit between the extracted and known features. In some embodiments, different features are given different weights determining the impact of the fit for each feature on the overall probability estimate. A probability threshold is set for the performance-related property, above which the diagnostics engine will report to a user that the performance-related property is present and below which the diagnostics engine will report to a user that the performance-related property is absent. In some embodiments, the diagnostics engine will report the generated probability to the user as well.

In some embodiments, further AI models and/or machine learning prediction models are employed to generate an outlook on the future life of the battery pack. In some embodiments, the outlook includes a prediction of the remaining useful life of the battery pack (i.e., a prediction of for how long the battery pack will reliably power the EV), and/or a financial value estimation (e.g., a prediction of the battery pack's resale value, scrap value, repair cost, and/or a prediction of the financial value of the EV as a whole). In such embodiments, the outlook is included in the report to the user.

In some embodiments, a final report is delivered to a device (e.g., computer or smartphone) via client application software which describes detected performance-related properties (e.g., by at least one of the property's type, extent, physical location, etc.) and the impact of those properties on the battery pack (such as a prediction of the remaining useful life of the battery pack and/or a financial value estimation thereof).

In step 1210, the report of the diagnostics engine is collected and used to update the AI model to generate more accurate reports and/or provide reports more quickly. For example, the features extracted by the AI model and/or the weights assigned to each feature when generating the probability estimate may be updated. In some embodiments, the AI model is updated using Bayesian hyperparameter optimization, for example, a tree-structured Parzen estimator. Different hyperparameters are used depending on the training of the AI model. For example, the hyperparameters for SVM include regularization parameters, kernel coefficients for the RBF kernel, and kernel types: linear, polynomial, and RBF. For Random Forest, the hyperparameters include the number of trees, the number of features to consider when looking for the best split, the maximum tree depth, the maximum features for each tree, maximum leaf nodes, and the minimum information gain to split a tree. For XGBoost, the hyperparameters include the learning rate, the number of boosting rounds, the minimum loss reduction required to make a split, and regularization parameters.

FIG. 13 is a block diagram illustrating an example MoE architecture 1300 for generating predictions related to a battery pack. The MoE architecture 1300 starts with a number (m) of signal transformers 1302, each receiving excitation data from a sensor that has collected excitation data corresponding to a specific physical location and diagnostic task. The signal transformers 1302 extract features from the received excitation data that are indicative of a performance-related property associated with the physical location and diagnostic task of the sensor which collected the excitation data. The features are extracted in the form of feature tokens. Sets of feature tokens X1 through Xm are created corresponding to each of the sensors on a one-to-one basis.

The feature tokens are input into both a sensor-specific MoE module 1304 and a sensor-task MoE module 1306. Each set of feature tokens X1 through Xm is passed to a sensor-specific MoE module 1304 which receives only the feature tokens in that set. The sensor-specific MoE module 1304 passes the feature tokens through a soft MoE layer, which uses a softmax-based assignment to assign a weighted combination of the feature tokens to each of a plurality of experts using a dispatch matrix. Each expert in the plurality of experts processes the weighted combination of the feature tokens using a stacked self-attention and multilayer perceptron (MLP) neural network layer and produces an output. Each of these outputs is combined into a weighted combination output, with the weight provided to the output of each expert being determined by a combine matrix. Thus, a weighted combination output Z1 through Zm is generated by each sensor-specific MoE module 1304 and corresponding to each of the m sensors. The dispatch and combine matrices are created based on the excitation data input and a learned routing matrix produced by an AI model based on training using other excitation data.

The sensor-task MoE module 1306 receives a concatenated set of all the feature token sets X1 through Xm as input. Each token in the concatenated set is assigned a dispatch weight based on the learned routing matrix and dispatched to an expert. The learned routing matrix facilitates dynamic connection between input tokens and tasks, and enables joint probability modeling of sensors modalities, experts and tasks. Each expert processes the token dispatched to the expert using a stacked self-attention and MLP layer coupled with a learned embedding specific to the diagnostic task and produces an output. The outputs corresponding to the same diagnostic task are combined in the same manner as described in relation to the sensor-specific MoE module 1304, resulting in task-specific fused features 1308 G1 through Gp for each of the p diagnostic tasks. The sensor-task MoE module 1306 prioritizes a high level of conditional mutual information between sensors performing a certain diagnostic task and experts which receive excitation data from those sensors. The sensor-task MoE module 1306 thereby learns to fuse task-dependent information from different sensors and avoid relying on only certain sensors in generating an output.

The task-specific fused features 1308 are combined with the sensor-specific outputs Z1 through Zm in a fusion block 1310. The fusion block 1310 applies a soft MoE layer to generate a prediction related to each diagnostic task. In some embodiments, the prediction is a probability estimate of a performance-related property related to the diagnostic task being present in the subject battery pack. A probability threshold is set for the performance-related property, above which the diagnostics engine will report to a user that the performance-related property is present and below which the diagnostics engine will report to a user that the performance-related property is absent. In some embodiments, the diagnostics engine will report the generated probability to the user as well.

### Computing Platform

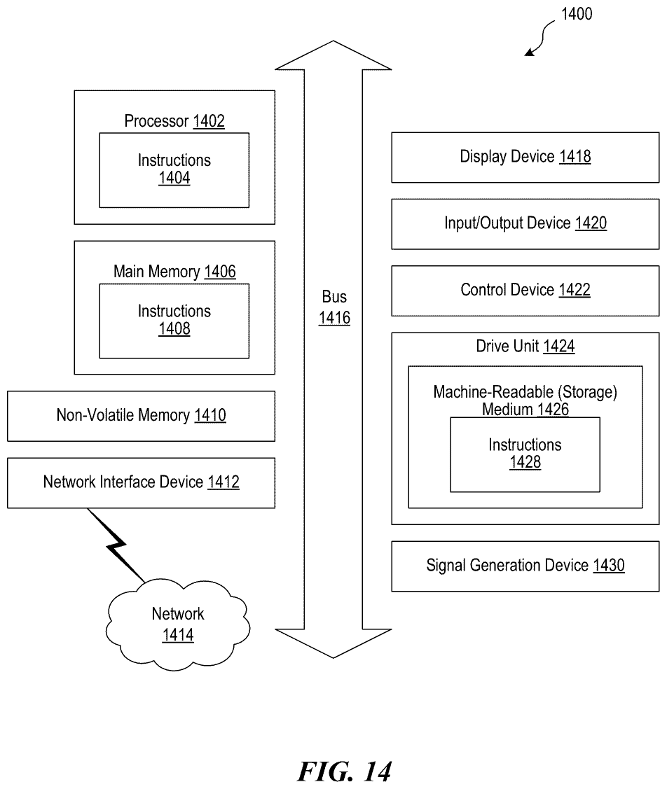

FIG. 14 is a block diagram illustrating an example computer system 1400, in accordance with one or more embodiments. In some embodiments, components of the example computer system 1400 are used to implement the software platforms described herein. At least some operations described herein can be implemented on the computer system 1400.

The computer system 1400 can include one or more central processing units (“processors”) 1402, main memory 1406, non-volatile memory 1410, network adapters 1412 (e.g., network interface), video displays 1418, input/output devices 1420, control devices 1422 (e.g., keyboard and pointing devices), drive units 1424 including a storage medium 1426, and a signal generation device 1420 that are communicatively connected to a bus 1416. The bus 1416 is illustrated as an abstraction that represents one or more physical buses and/or point-to-point connections that are connected by appropriate bridges, adapters, or controllers. The bus 1416, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The computer system 1400 can share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 1400.

While the main memory 1406, non-volatile memory 1410, and storage medium 1426 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 1428. The term “machine-readable medium” and “storage medium” shall also be taken to include any medium that is capable of storing, encoding, or carrying a set of instructions for execution by the computer system 1400. In some embodiments, the non-volatile memory 1410 or the storage medium 1426 is a non-transitory, computer-readable storage medium storing computer instructions, which can be executed by the one or more central processing units (“processors”) 1402 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 1404, 1408, 1428) set at various times in various memory and storage devices in a computer device. When read and executed by the one or more processors 1402, the instruction(s) cause the computer system 1400 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 1410, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 1412 enables the computer system 1400 to mediate data in a network 1414 with an entity that is external to the computer system 1400 through any communication protocol supported by the computer system 1400 and the external entity. The network adapter 1412 can include a network adapter card, a wireless network interface card, a router, an access point, a wireless router, a switch, a multilayer switch, a protocol converter, a gateway, a bridge, a bridge router, a hub, a digital media receiver, and/or a repeater.

The network adapter 1412 can include a firewall that governs and/or manages permission to access proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall can additionally manage and/or have access to an access control list that details permissions including the access and operation rights of an object by an individual, a machine, and/or an application, and the circumstances under which the permission rights stand.

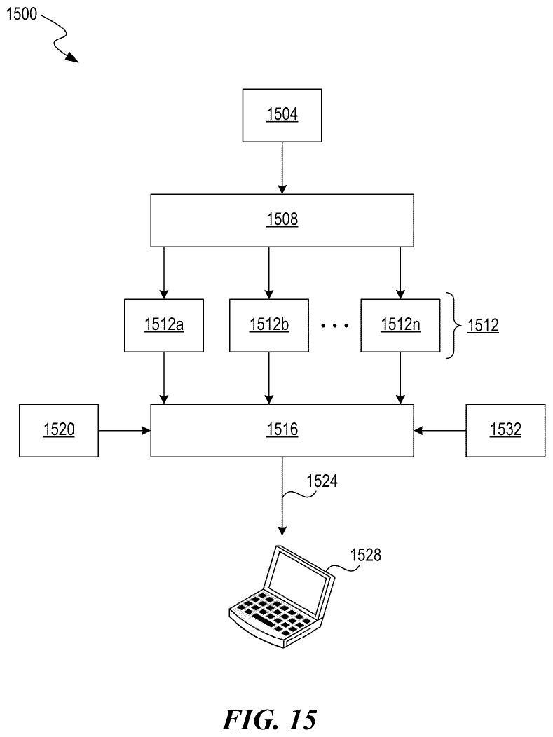

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example ML system 1500 illustrated and described in more detail with reference to FIG. 15.

### Machine Learning System

FIG. 15 is a block diagram illustrating an example ML system 1500, in accordance with one or more embodiments. The ML system 1500 is implemented using components of the example computer system 1400 illustrated and described in more detail with reference to FIG. 14. Likewise, embodiments of the ML system 1500 can include different and/or additional components or be connected in different ways. The ML system 1500 is sometimes referred to as a ML module.

The ML system 1500 includes a feature extraction module 1508 implemented using components of the example computer system 1400 illustrated and described in more detail with reference to FIG. 14. In some embodiments, the feature extraction module 1508 extracts a feature vector 1512 from input data 1504. For example, the input data 1504 can include one or more images, sets of text, audio files, or video files. The feature vector 1512 includes features 2512a, 2512b, 2512n. The feature extraction module 1508 reduces the redundancy in the input data 1504, e.g., repetitive data values, to transform the input data 1504 into the reduced set of features 1512, e.g., features 2512a, 2512b, . . . 2512n. The feature vector 1512 contains the relevant information from the input data 1504, such that events or data value thresholds of interest can be identified by the ML model 1516 by using this reduced representation. In some example embodiments, dimensionality reduction techniques, such as principal component analysis (PCA) or autoencoders are used by the feature extraction module 1508.

In alternate embodiments, the ML model 1516 performs deep learning (also known as deep structured learning or hierarchical learning) directly on the input data 1504 to learn data representations, as opposed to using task-specific algorithms. In deep learning, no explicit feature extraction is performed; the features 1512 are implicitly extracted by the ML system 1500. For example, the ML model 1516 can use a cascade of multiple layers of nonlinear processing units for implicit feature extraction and transformation. Each successive layer uses the output from the previous layer as input. The ML model 1516 can learn in supervised (e.g., classification) and/or unsupervised (e.g., pattern analysis) modes. The ML model 1516 can learn multiple levels of representations that correspond to different levels of abstraction, wherein the different levels form a hierarchy of concepts. In this manner, the ML model 1516 can be configured to differentiate features of interest from background features.

In alternative example embodiments, the ML model 1516, e.g., in the form of a CNN generates the output 1524, without the need for feature extraction, directly from the input data 1504. The output 1524 is provided to the computer device 1528. The computer device 1528 is a server, computer, tablet, smartphone, smart speaker, etc., implemented using components of the example computer system 1400 illustrated and described in more detail with reference to FIG. 14. In some embodiments, the steps performed by the ML system 1500 are stored in memory on the computer device 1528 for execution. In other embodiments, the output 1524 is displayed on high-definition monitors.

A CNN is a type of feed-forward artificial neural network in which the connectivity pattern between its neurons is inspired by the organization of a visual cortex. Individual cortical neurons respond to stimuli in a restricted region of space known as the receptive field. The receptive fields of different neurons partially overlap such that they tile the visual field. The response of an individual neuron to stimuli within its receptive field can be approximated mathematically by a convolution operation. CNNs are based on biological processes and are variations of multilayer perceptrons designed to use minimal amounts of preprocessing.

The ML model 1516 can be a CNN that includes both convolutional layers and max pooling layers. The architecture of the ML model 1516 can be “fully convolutional,” which means that variable sized sensor data vectors can be fed into it. For all convolutional layers, the ML model 1516 can specify a kernel size, a stride of the convolution, and an amount of zero padding applied to the input of that layer. For the pooling layers, the ML model 1516 can specify the kernel size and stride of the pooling.

In some embodiments, the ML system 1500 trains the ML model 1516, based on the training data 1520, to correlate the feature vector 1512 to expected outputs in the training data 1520. As part of the training of the ML model 1516, the ML system 1500 forms a training set of features and training labels by identifying a positive training set of features that have been determined to have a desired property in question and a negative training set of features that lack the property in question. The ML system 1500 applies ML techniques to train the ML model 1516, that when applied to the feature vector 1512, outputs indications of whether the feature vector 1512 has an associated desired property or properties.

The ML system 1500 can use supervised ML to train the ML model 1516, with features from the training sets serving as the inputs. In some embodiments, different ML techniques, such as support vector machine (SVM), regression, naïve Bayes, random forests, neural networks, etc., are used. In some example embodiments, a validation set 1532 is formed of additional features, other than those in the training data 1520, which have already been determined to have or to lack the property in question. The ML system 1500 applies the trained ML model 1516 to the features of the validation set 1532 to quantify the accuracy of the ML model 1516. In some embodiments, the ML system 1500 iteratively re-trains the ML model 1516 until the occurrence of a stopping condition, such as the accuracy measurement indication that the ML model 1516 is sufficiently accurate, or a number of training rounds having taken place.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

Consequently, alternative language and synonyms can be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense.

I/We claim:

1. A method of non-destructive inspection of a battery pack based on vibration analysis comprising:
positioning a mechanical excitation probe in contact with an exterior facing surface of an electric vehicle (EV), wherein positioning of the mechanical excitation probe is adjusted using a gantry coupled with the mechanical excitation probe;
positioning a first differential sensor probe in contact with the EV at a predetermined distance from the mechanical excitation probe;
vibrating the exterior facing surface with the mechanical excitation probe, wherein an excitation signal corresponding to the vibrating passes through a battery pack of the EV;
collecting, via the first differential sensor probe, first excitation data associated with a measurement of the excitation signal after the excitation signal passes through the battery pack; and
receiving an indication, based on the first excitation data, of a performance-related property of the battery pack.

2. The method of claim 1, further comprising:
inputting the first excitation data into a product-specific database corresponding to the battery pack, wherein an artificial intelligence (AI) model is trained using content in the product-specific database to extract features from excitation data indicative of a product-specific performance-related property associated with the battery pack, wherein the product-specific performance-related property is one of external physical damage, internal structural damage, welding cracks, enclosure sealing damage, mechanical fastener torque loss or damage, adhesive delamination, physical damage of connectors, battery cell deformation, severe corrosion, coolant leakage, or abrasion between parts;
inputting the first excitation data into the AI model, wherein the AI model extracts features from the first excitation data indicative of the product-specific performance-related property;
receiving, from the AI model, a probability associated with the product-specific performance-related property based on the extracted features; and
instructing the AI model to update the features extracted by the AI model upon receiving excitation data.

3. The method of claim 1, wherein:
the first excitation data describes at least one of an amplitude (peak and valley values), a pattern (gradient, shape, dense/sparse features), a three-axis (x-y-z) vibration speed, a displacement, a frequency, or an acceleration associated with the excitation signal after the excitation signal passes through the battery pack.

4. The method of claim 1, further comprising:
estimating, based on the first excitation data and using at least one of a machine learning model or an AI model, at least one of a remaining useful life of the battery pack or a financial value prediction of the battery pack.

5. The method of claim 1, wherein:
the exterior facing surface is the battery pack and the excitation signal passes only through the battery pack before being measured by the differential sensor probe.

6. The method of claim 1, further comprising:
positioning a rover under the EV, wherein the gantry is mounted to the rover; and
adjusting the positioning of the mechanical excitation probe by moving the rover, wherein the adjustment is of a larger magnitude than an adjustment made using the gantry alone.

7. The method of claim 1, further comprising:
collecting, contemporaneously with collecting the first excitation data, second excitation data associated with a measurement of the excitation signal after the excitation signal passes through the battery pack via a second differential sensor probe in a different physical location than the first differential sensor probe and in contact with the EV;
combining the first excitation data and second excitation data into a differential data set; and
receiving an indication, based on the differential data set, of a performance-related property of the battery pack.

8. The method of claim 7, wherein:
the first and second excitation data are sample measurements of the excitation signal, wherein the sample measurements are collected at non-continuous predetermined sampling time intervals.

9. A system for non-destructive inspection of a battery pack based on vibration analysis, comprising:
a mechanical excitation probe in contact with an exterior facing surface of an electric vehicle (EV), wherein the mechanical excitation probe vibrates the exterior facing surface, wherein an excitation signal corresponding to the vibrating travels through a battery pack of the EV;
a gantry coupled with the mechanical excitation probe, wherein positioning of the mechanical excitation probe is adjusted using the gantry;
a first differential sensor probe in contact with the EV at a predetermined distance from the mechanical excitation probe; and
a processor configured to:
receive first excitation data associated with a measurement of the excitation signal after the excitation signal passes through the battery pack from the first differential sensor probe, and
receive an indication, based on the first excitation data, of a performance-related property of the battery pack.

10. The system of claim 9, wherein the processor is further configured to:
input the first excitation data into a product-specific database corresponding to the battery pack, wherein an artificial intelligence (AI) model is trained using content in the product-specific database to extract features from excitation data indicative of a product-specific performance-related property associated with the battery pack, wherein the product-specific performance-related property is one of external physical damage, internal structural damage, welding cracks, enclosure sealing damage, mechanical fastener torque loss or damage, adhesive delamination, physical damage of connectors, battery cell deformation, severe corrosion, coolant leakage, or abrasion between parts;
input the first excitation data into the AI model, wherein the AI model extracts features from the first excitation data indicative of the product-specific performance-related property;
receive, from the AI model, a probability associated with the product-specific performance-related property based on the extracted features; and
instruct the AI model to update the features extracted by the AI model upon receiving excitation data.

11. The system of claim 9, wherein:
the first excitation data describes at least one of an amplitude (peak and valley values), a pattern (gradient, shape, dense/sparse features), a three-axis (x-y-z) vibration speed, a displacement, a frequency, or an acceleration associated with the excitation signal after the excitation signal passes through the battery pack.

12. The system of claim 9, wherein:
the gantry is mounted to a rover positioned under the EV, wherein the rover is configured to adjust the positioning of the mechanical excitation probe by a larger magnitude than adjustments made using the gantry alone.

13. The system of claim 9, further comprising:
a second differential sensor probe in a different physical location than the first differential sensor probe and in contact with an exterior facing surface of the EV.

14. The system of claim 13, wherein the processor is further configured to:
receive, contemporaneously with receiving the first excitation data, second excitation data associated with a measurement of the excitation signal after the excitation signal passes through the battery pack from the second differential sensor probe;
combine the first excitation data and second excitation data into a differential data set; and
receive an indication, based on the differential data set, of either a presence or an absence of a failure mode of the battery pack.

15. The system of claim 14, wherein:
the first and second excitation data are sample measurements of the excitation signal, wherein the sample measurements are collected at non-continuous predetermined sampling time intervals.

16. A device for non-destructively inspecting a battery pack based on vibration analysis, comprising:
a mechanical excitation probe;
a gantry coupled with the mechanical excitation probe;
a first differential sensor probe;
a rover, wherein the gantry is mounted to the rover, wherein the rover is used to adjust positioning of the mechanical excitation probe by a larger magnitude than an adjustment made using the gantry alone; and
a processor configured to:
receive first excitation data associated with a battery pack of an EV from the first differential sensor probe, and
receive an indication, based on the first excitation data, of a performance-related property of the battery pack.

17. The device of claim 16, wherein the processor is further configured to:
input the first excitation data into a product-specific database corresponding to the battery pack, wherein an artificial intelligence (AI) model is trained using content in the product-specific database to extract features from excitation data indicative of a product-specific performance-related property associated with the battery pack, wherein the product-specific performance-related property is one of external physical damage, internal structural damage, welding cracks, enclosure sealing damage, mechanical fastener torque loss or damage, adhesive delamination, physical damage of connectors, battery cell deformation, severe corrosion, coolant leakage, or abrasion between parts;
input the first excitation data into the AI model, wherein the AI model extracts features from the first excitation data indicative of the product-specific performance-related property;
receive, from the AI model, a probability associated with the product-specific performance-related property based on the extracted features; and
instruct the AI model to update the features extracted by the AI model upon receiving excitation data.

18. The device of claim 16, further comprising:
a second differential sensor probe, wherein the second differential sensor probe is moveable independently of the first differential sensor probe.

19. The device of claim 18, wherein the processor is further configured to:
receive, contemporaneously with receiving the first excitation data, second excitation data associated with the battery pack from the second differential sensor probe;
combine the first excitation data and second excitation data into a differential data set; and
receive an indication, based on the differential data set, of a performance-related property of the battery pack.

20. The device of claim 19, wherein:
the first and second excitation data are sample measurements of the excitation signal, wherein the sample measurements are collected at non-continuous predetermined sampling time intervals.
